(19) United States
(12) Patent Application Publication
(10) Pub. No.: US 2007/0274499 A1
(43) Pub. Date: Nov. 29, 2007

(54) Intelligent ring, tone or announcement searching, pickup and forwarding in a mixed VoIP and telephony network

(76) Inventor: James D. Bennett, San Clemente, CA (US)

Correspondence Address: GARLICK HARRISON & MARKISON, P.O. BOX 160727, AUSTIN, TX, 78716-0727, US

(21) Appl. No.: 11/683,562

(22) Filed: Mar. 8, 2007

Related U.S. Application Data
(60) Provisional application No. 60/780,698, filed on Mar. 8, 2006.

(51) Int. Cl. H04M 3/42

(52) U.S. Cl. 379/220.01

(57) ABSTRACT

Telephony circuitry, within calling or recipient telephony devices, supports the exchange of communications between the telephony devices. These telephony devices may include a screen and a user input device. User input interface circuitry receives input signals from the user input device. Display interface circuitry couples to the screen. Communication interface circuitry couples switched telephony networks to support a number of pathways. Processing circuitry communicatively couples to the display interface circuitry, the communication interface circuitry, and the user input interface circuitry. Memory stores contact associations, where the contact association includes recipient availability information and contact handle associated with the recipient. The processing circuitry responds to input signals received via the user input interface circuitry to cause the display of the contact association through interaction with the display interface circuitry. The processing circuitry then responds to a second input signals by establishing the call session request to recipient telephony device(s) based on the recipient availability information.

### CROSS REFERENCE TO RELATED APPLICATIONS

This application claims priority to U.S. Provisional Patent Application Ser. No. 60/78,698, entitled “INTELLIGENT RING, TONE OR ANNOUNCEMENT SEARCHING, PICKUP AND FORWARDING IN A MIXED VOIP AND TELEPHONY NETWORK,” filed Mar. 8, 2006, which is incorporated herein by reference for all purposes.

### TECHNICAL FIELD OF THE INVENTION

This invention relates generally to network based communications and more particularly to management of packet data communications between client terminals.

### BACKGROUND OF THE INVENTION

Communication technologies currently allow Internet or network based voice communications. Internet voice communications allow users to make telephone calls using a computer network or other data network. Internet voice communications convert a voice signal into a digital packetized signal that travels over the network to the destination terminal. These Internet-based communications may be made through a personal computer (PC) attached to the Internet or other like network, or a traditional telephone having an adaptor that allows the traditional telephone to interface and place phone calls over the network. Additionally, some devices may facilitate communications within multiple networks. For example, a single device may serve as a traditional phone, cell phone, and/or Internet phone. Such devices are typically shared in the home by multiple family members.

One such Internet Protocol (IP) enabled service is known as Voice over Internet protocol (VoIP). VoIP allows voice communications to be packetized and exchanged using a broadband Internet connection instead of an analog or a traditional phone line. However, these Internet voice services currently allow users to call only other users that utilize the same service provider or to users available through the public switched telephone network (PSTN). This limitation may be imposed by incompatible CODECs chosen to packetize the voice communications, network addressing issues or other like difficulties.

The Internet has also facilitated text messaging between two or more users, first with email, and now instant messaging (IM). Email communications do not require common service providers to be used by both the originating terminal and the destination terminal. An email address provides vectoring information to identify the communications intended destination and is made of several parts. The first part of the address is a username, identifier, or handle that identifies a unique user within a server. The ampersand (@) separates the username from the host name. The host name uniquely identifies the server computer network and is the second part of the email address. This host name may include a suffix that identifies the kind of organization operating the server such as .com, .edu, .gov, mil, etc. This format for an email address identifies a location to which an email can be delivered. Since network based communications often require IP addresses for the destination terminal, and these addresses frequently change, Internet-based voice communications currently lack this addressing ability.

IM is a form of electronic communication which involves immediate correspondence between two or more users of a common IM service who are online simultaneously. To access such functionality, each user downloads and installs the same IM service provider's support software on their personal computing device. When in operation, the software attempts to maintain with a central server of that IM service provider the current IP address of the underlying user's personal computing device. If two users have such software in operation, either may initiate a correspondence to the other by retrieving the IP address of the other from the central server. However, IM, unlike email, requires both of the users to employ the same software and central server, i.e., the same IM service provider. Popular instant messaging services supporting at least textual correspondence include AOL's Instant Messenger (AIM), Microsoft MSN Messenger and Yahoo Messenger, for example. Some recent versions of IM also support voice communications (correspondence) between these users.

Instead of assigning permanent IP addresses to an individual user or computing device, many Internet Service Providers (ISPs) assign temporary IP addresses using, for example, a dynamic host configuration protocol (DHCP). Using the DHCP protocol, an ISP's DHCP server allocates and reallocates a pool of IP addresses as client devices log in and out. Upon logging in, each client device request the assignment of an IP address. The DHCP server responds by assigning a currently unused IP address from its pool. When a client device logs out or otherwise disconnects from the network the DHCP server is free to reallocate the IP address to another client device. DHCP servers also maintain a database that associates each client device with its currently assigned IP address. With such dynamic address allocation, a client device may have a different IP address every time the device connects to the network. Additionally, DHCP servers may also support a mix of static and dynamic IP addresses.

The IP addresses of most client devices frequently change; using a current IP address to permanently and uniquely identify each client device is not always possible. Thus, when a user of one client device desires to contact another, a service provider can assist if both sign up for that service provider's maintenance and sharing of current IP addresses, i.e., if both users become members. More specifically, a typical IM or VoIP service provider maintains a database on a central server. The database associates each member's “name identifier” with the current IP addresses of that member's client device(s). To maintain an accurate database, each client device delivers its underlying name identifier and current IP address to the central server for updating. The service provider then uses this database to route communications between devices. Only through such updating can a member reasonably expect to receive incoming service. When a communication is initiated from a user serviced by a different service provider, there is no access to addressing information. Thus, a user having a first service provider is unable to establish a connection or communication pathway to a destination terminal serviced by a second service provider.

Static IP addresses are also in use, but are less common for client devices because of their frequent network detachment for relatively long periods before reattaching. Therefore, a substantial percentage of such statically assigned IP addresses are not in use at any given time. Additionally, as devices change ISPs, even static IP addresses previously assigned will change.

Users may be associated with a number of devices and service providers. This creates a problem in determining which devices to direct communications to. Improved ways of handling incoming and outgoing communications between devices is required to properly route communications to the appropriate recipients and devices. Further limitations and disadvantages of conventional and traditional call routing systems and related functionality will become apparent to one of ordinary skill in the art through comparison with the present invention described herein.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a system diagram illustrating network infrastructure operable to support calls between telephony devices wherein calls may be routed simultaneously or sequentially to any set or subset of these telephony devices in accordance with embodiments of the present invention;

FIG. 2 depicts various cross-reference identifiers which may include one or more user identifiers, terminal identifiers, service provider identifiers, and associated meta data that may be used to determine how to route calls in accordance with embodiments of the present invention;

FIG. 3 is a schematic block diagram illustrating telephony circuitry of one of the client terminals of FIG. 1, according to one embodiment of the present invention;

FIG. 4 illustrates how information or communications may flow between telephony devices in order to facilitate a call or communication between the caller and a callee accessible through one or more telephony devices in accordance with one or more embodiments of the present invention;

FIG. 5 illustrates how information or communications may flow between client devices and service providers in order to facilitate a call or communication between the first client device and a destination client device wherein both client devices are serviced by different service providers in accordance with one or more embodiments of the present invention;

FIG. 6 depicts various display sequences of a client telephony device screen, each sequence illustrating various interactions with one or more phonebook databases to facilitate a call or communication exchange in accordance with one or more embodiments of the present invention;

FIG. 7 depicts various further examples of a client telephony device's screen which displays select portions of content, including media types, recipient availability, and available networks, in accordance with one or more embodiments of the present invention;

FIGS. 8A and 8B provide logic flow diagrams illustrating a method of establishing a call session to one or more destination client terminals in accordance with one or more embodiments of the present invention;

FIG. 9 provides a logic flow diagram illustrating how individual client devices may communicate network address information and meta data to a service provider or third party database wherein this information is used to properly route calls in accordance with one or more embodiments of the present invention;

FIG. 10 provides a logic flow diagram wherein a first telephony device initiates a call to one or more telephony devices where call announcements may be based on expected callee proximity to the recipient device in accordance with one or more embodiments of the present invention;

### DETAILED DESCRIPTION OF THE INVENTION

Preferred embodiments of the present invention are illustrated in the figures, like numerals being used to refer to like and corresponding parts of the various drawings.

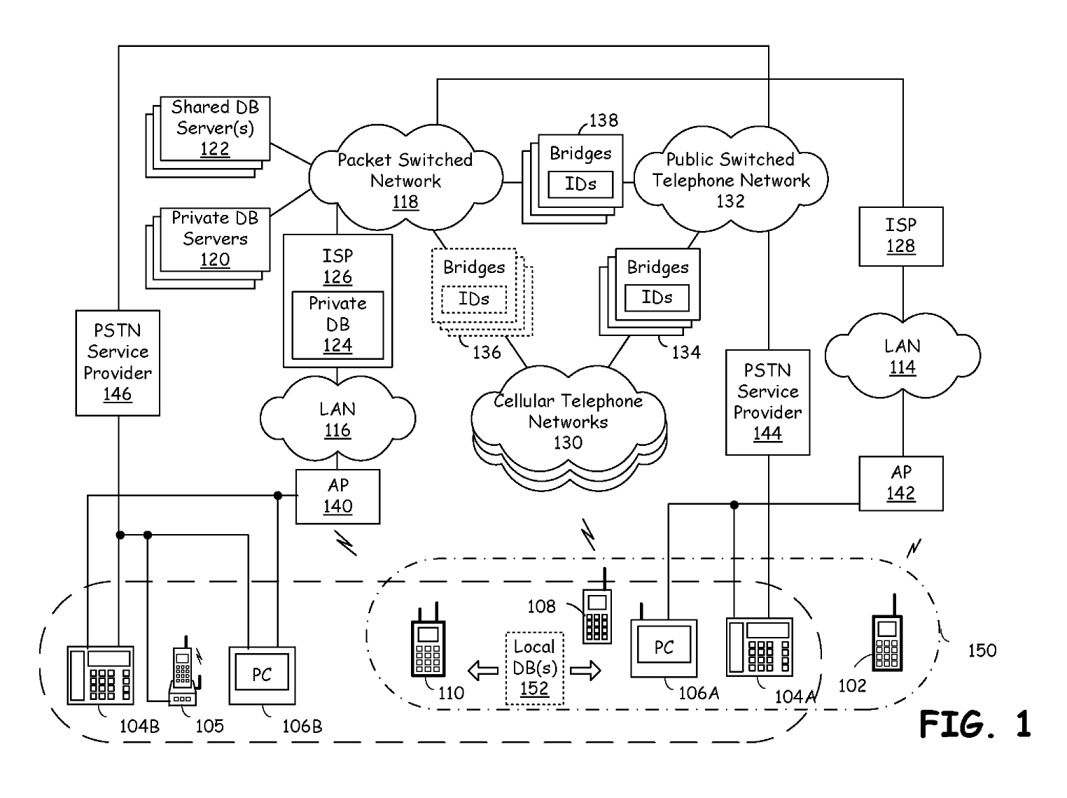

FIG. 1 is a system diagram illustrating network infrastructure operable to support calls between client telephony devices. These calls may be routed simultaneously or sequentially to any set or sub set of telephony devices associated with the recipient. Therein, each of a plurality of client telephony devices utilizes one or a plurality of wired and/or wireless interfaces to initiate, receive and maintain call sessions. Various upstream networks provide the call session pathways between such interfaces of two or more of the client telephony devices.

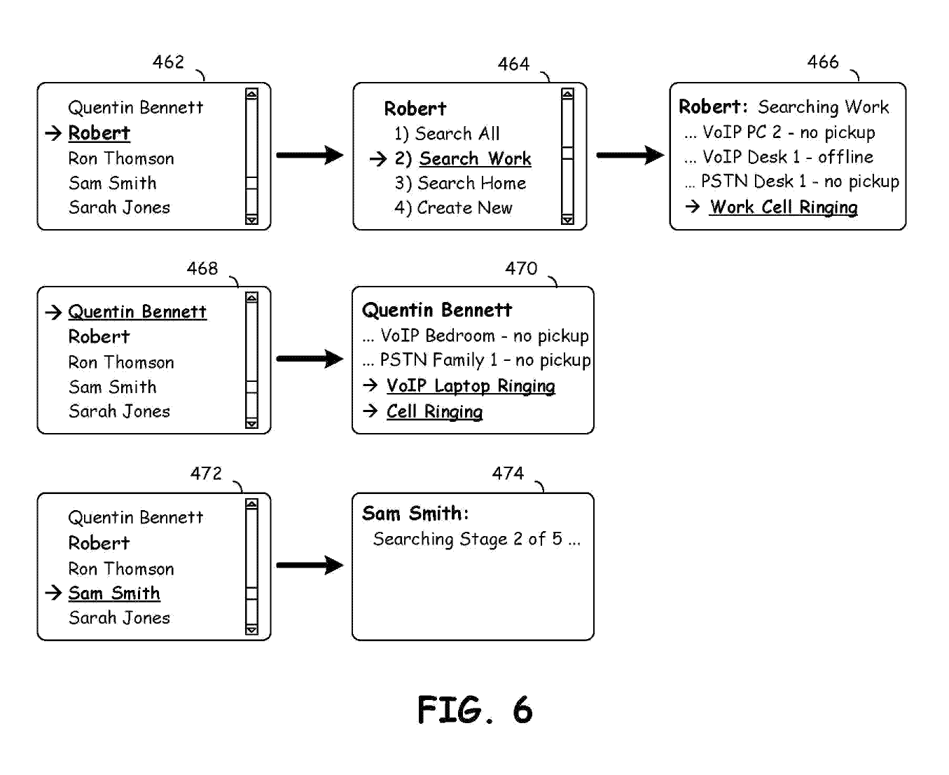

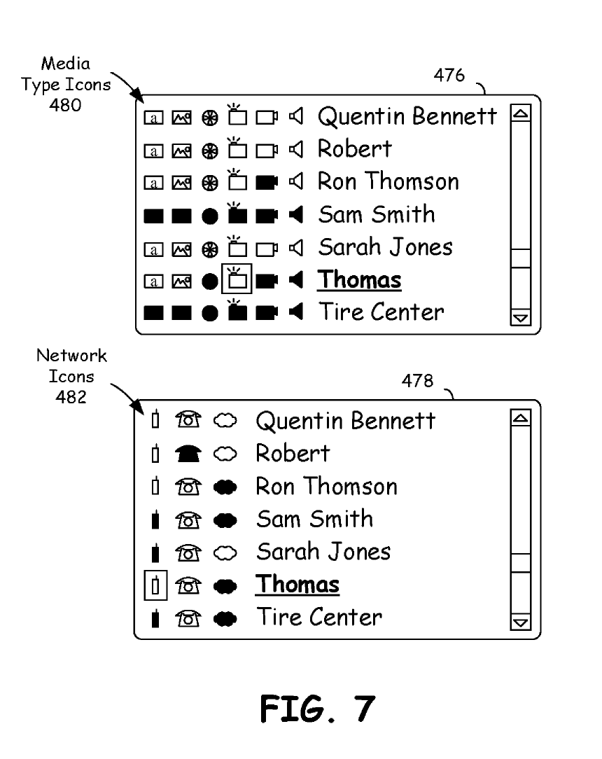

Client side phonebook application software (not shown) may run on each client telephony device, while server side phonebook application software runs on each server. These client and server software applications may maintain updated information regarding the recipient availability various client telephony devices via entries to the phonebook database(s). Each client software application also presents on-screen phonebook display sequences such as those presented in FIGS. 6 and 7, so that a user of the client telephony device can establish and maintain call sessions.

Exemplary information stored in a phonebook entry includes identity of all of a potential recipient's client telephony devices, recipient availability information capabilities of such devices and bandwidth limitations, potential recipient handles, network addresses, telephone numbers, etc. The recipient information may include schedules, user activity or phone activity associated with the recipient and recipient devices. The phonebook database accessed by the phonebook management software may be local, remote or distributed there between. A local phonebook database (portion) may be stored within the client telephony device itself. A remote phonebook database (portions) is distributed across others of the client telephony devices and/or across one or more supporting servers. Such distribution may be on an entry by entry basis or based on the type of information being stored. For example, most of the phonebook entries might be stored locally while some are retrieved as the need arises, or personalization information for all entries might be stored locally with the remainder of the phonebook entry information being remotely stored and maintained.

For example, a user, through interaction with the phonebook application software may be able to select someone to call, i.e., a recipient, evaluate the recipient's availability and capabilities of the recipient's currently available client telephony devices, consider the recipient's recent activity, and select pathways and procedures for establishing a calling session with the recipient. This may involve simultaneously or sequentially delivering the call to sets or subsets of recipient telephony devices based on recipient availability and telephony device capability. For example, a first set of recipient telephony devices may be identified based on recipient availability and/or media capability. A second set of recipient telephony devices may be identified based on similar criteria. When attempting to establish a call session, the call session request may result in a first type of call announcement (i.e. audible ring or tone) to the first set and a second type of call announcement (i.e. visual indicator only) for the second set. However establishing the call session by accepting the call request on any telephony device may halt the call announcements on all devices.

Within the network infrastructure, a variety of exemplary types of client telephony devices (or client terminals) are supported. Some of the client telephony devices are handheld devices such as cordless phone 102, cellular & Internet telephony device 103, cellular phone 104 and Internet phone 106. Other client telephony devices comprise computing devices such as PC (Personal Computer) 107 and 108. Yet others comprise desktop phones, such as desktop phones 109 and 110. Client terminal 108 is a personnel computer. Client terminal 108 may be a cellular or wireless telephone. Client terminal 110 may be a wireless local area network (WLAN)/cellular telephone operable to communicate either through a WLAN or cellular telephone network. Client terminal 112 is a laptop computer. Client terminal 104 is a wired terminal such as a PSTN telephone.

These client terminals may support wired or wireless communications according to one or more communication protocols including, but not limited to, Wireless Local Area Network (WLAN) protocols such as IEEE 802.11a, b, g, and n, Wireless Personal Area Network (WPAN) protocols such as Bluetooth, cellular protocols such as GSM, IS-95, 1xRTT, 1xEV, etc., and/or other wireless protocols. Client terminals may also support wireless communications via cellular telephone networks 130 and in the case of client terminal 103 wireless communications via a wireless network interface to an associated access point such as access point 140. Further, each of the client terminals may also support one or more wired communications and wired communication standards, including one or more versions of the Ethernet standard and/or other wired standards.

The network infrastructure in FIG. 1 further includes local area networks (LAN) 114 and 116, a packet switch network 118, such as but not limited to the Internet, public switch telephone network (PSTN) 132, cellular telephone networks 130, database servers 120 and 122, private database 124, PSTN service providers 144 and 146, access points (AP) 140 and 142, network bridges 134, 136, and 138, and packet switch network service providers 126 and 128. The wired links include actual wires, optical connections, and/or wired equivalent connectivity.

Servers 120, 122 and private database 124 couple to the packet switched network 118 and may communicate with the client devices 102 through 110. This may be accomplished through wired or wireless links such as those provided by LAN 114 and 116 or AP 140 and 142. These links allow client terminals to access the distributed phonebook database contained within the servers. Further, remote and locally portions of the phonebook database may be updated by phonebook application software executed within this network environment. To support and facilitate calls, the client devices each use client side phonebook application software and phonebook database(s) (either local or remote). Various mechanisms may be used to update the local and remote phonebook databases. In one instance, the local phonebooks are only updated through direct interaction and without any server support. Alternatively, the local phonebooks may be updated through interaction with one or more public/private databases. Furthermore, other client device(s) may use the client side phonebook application software without a local database. In this case, the information used comes from the remote (i.e. network based) database. Cellular phone 104 may use GPRS/EDGE or other cellular data pathways for a shadow version of a remote database. Additionally, any combination of the described methods may be used to provide current information including recipient availability and schedule information to the phonebook database(s).

Access points 140 and 142 are operable to support a WLAN protocol such as one or more of the IEEE 802.11 communication protocols and/or a WPAN communication protocol such as the Bluetooth protocol.

Client terminals may associate with one or more access points or networks at any time. For example, client terminals 102 and/or 104 may be members of LAN 114 and the WLAN of AP 142. These associations may change over time. For example, if client device 102 moves within the coverage area of access point 140, client terminal 102 will associate with access point 140. Further, when client terminal 102 is within the operating range of other access points, client terminal 102 will associate with these access points as well. However, when client terminal 102 moves outside of one or more of the operating ranges of any access points, it may disassociate (by default) from one or more of the access points. This and other live information may be updated to the phonebook database to ensure current addressing information is available. Such activity may indicate availability via that client terminal. Similarly a client terminal with no movement or recent network addresses may indicate a decreased likelihood of recipient availability through that terminal.

The association of the client terminals with the various wireless and wired networks results in the client terminals potentially being assigned a number of (Internet Protocol) IP addresses. The client terminals may then associate internally their username, handle or identifier with their network address (i.e. IP address in the case of internet communications). The client terminals then share the addressing information and cross reference identifies with service providers or public/private databases via the portion of the phonebook application software executed within the client terminals.

The network infrastructure provided in FIG. 1 may support call exchange between a first client terminal and a second client terminal. In these embodiments the calling client terminals access, a phonebook database (local or distributed) through phonebook application software to retrieve addressing information using a cross-reference identifier, i.e., user name, handle. The client terminal may use a user name, handle, or other like identifier as an input, as a cross-reference identifier, in order to retrieve an IP address or address vectoring information in order to initiate and manage calls between client terminals serviced by different service providers. As an individual user may be associated with more than one device, calls may be directed to a number of devices wherein the selection of devices may be prioritized. This information may be stored locally or remotely to servers accessible through the network. The recipient availability information may be used by the calling terminal or recipient terminal. The calling terminal may select a particular pathway based on recipient availability while the recipient terminal may redirect or proxy the call based on the recipient availability.

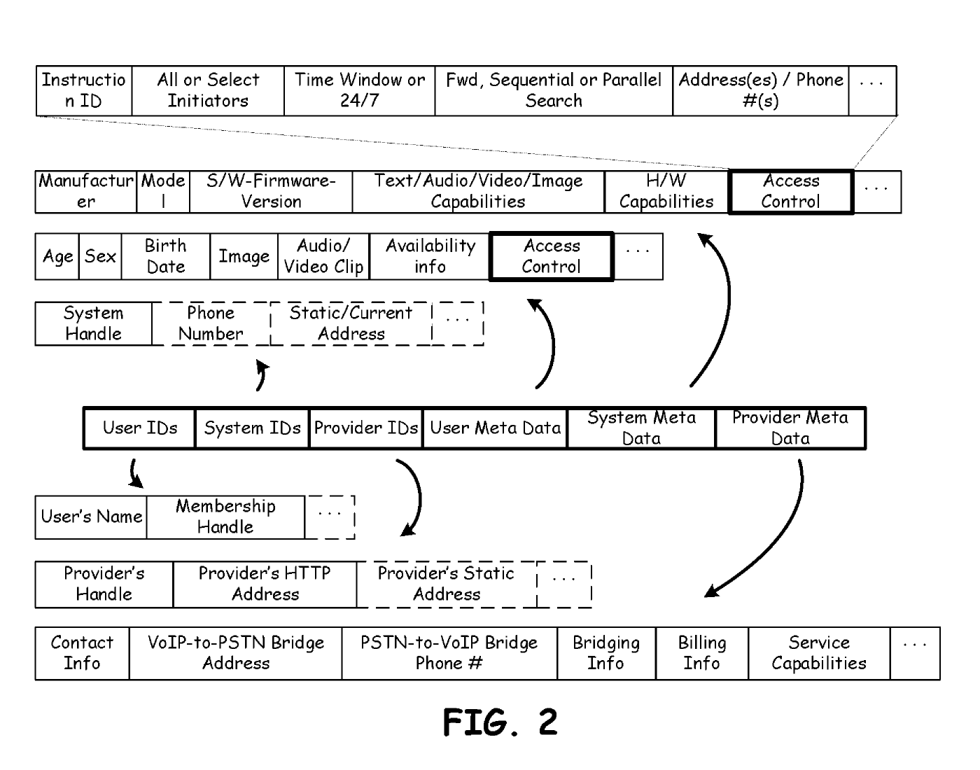

Client terminal identifiers, such as a username or handle, may, like an email address, contain a first part that identifies the user and a second part that identifies the host or service provider. Additionally, each client terminal may be assigned at least one unique IP address when registered with a servicing Internet Servicing provider (ISP) which may change over time. Client terminals register with the service provider in order to enable communications via the service provider. Either the client terminal or the service provider may then store a network or IP address associated with the client terminal and username, identifier or handle within the phonebook database. Contained within the phonebook database is information such as that to be discussed with reference to FIG. 2. As an individual user may be associated with more than one device, calls may be directed to a number of devices. Furthermore, as the individual devices may be associated with more than one user, the announcements of an incoming call to individual devices may be prioritized based on information contained within the phonebook database and client terminals.

Client terminals may further maintain local status parameters of that client terminal and associated and current users. (i.e. recipient availability information) The current user may be pseudo-permanently preset to a specific user, or may change as a user interacts with a device. For example, logins with or without passwords (including “guest”) may be associated with each device or may merely involve one or more button selections to identify the user before the device can be used. In case of PC client terminals, the operating system user login identity may be borrowed. Each client terminal may receive current status parameter information if authorized from each other device regarding such other devices and associated and current users. Each device may also maintain and exchange all or a portion of the status parameters from other devices outside the immediate family such as friends and business associates.

Individuals' client terminals may associatively store client handle, metadata, (that includes recipient availability information terminal media capabilities) and network address information associated with individuals to which calls may be directed within a local phonebook database 152 or remote database. This information may be stored internally within each of the client terminals or may be stored to a local database 152. When stored to a database this information may be accessible through a servicing network such as a LAN, WAN, WPAN, or the packet switch network.

Metadata associated with users and client handles may be used to manage network based communications (call delivery) to the client terminals. For example, a user or client handle may be primarily associated with an individual client terminal, such as client terminal 110. In one example, client terminal 110 may be located within home office. However, metadata contained within the client terminal or phonebook database may indicate that the user or client handle primarily associated with the home office client terminal may be available via a wireless client terminal 105. The phonebook application may determine the likelihood of user proximity to individual client terminal based on current location information, terminal usage or movement, historical information, time of day information, schedule, user provided information or other like information. Instead of primarily routing the call to user terminal 110, the call may be routed to wireless client terminal 105. Alternatively, another embodiment may initially deliver the network based communication to the client terminal having the greatest likelihood of user proximity to the client terminal and then proxied to another client terminal. For example, again the call may initially be delivered to a client terminal located in the home office such as client terminal 110. When the call is not successfully delivered to client terminal 110, an announcement either audible or visual may be displayed on all client terminals associated with the user.

Alternative to proxying or forwarding of the call, a call may be routed from client terminal 110 to an alternative client terminal such as wireless terminal 105. This may be done by informing the initiating phonebook application within the calling client terminal of a new network routing address of the client terminal to which the network based communication is routed. This may be accomplished by the phonebook application within the intended destination terminal updating the phonebook database when the call session request is initially received. This updated information may then be used to announce the call.

FIG. 2 depicts examples of associatively coupled information that may be contained and associatively stored within the one or more phonebook database in accordance with an embodiment of the present invention. The information may be stored within phonebook databases on client terminals or servers available through the network. This data may be populated through web-based interfaces, from other databases, or reports from client terminals and service providers to the phonebook database. The reports may be made by phonebook application software running within client terminals, service provider servers, or other applications that sample publicly available databases. For example, a database associated with PSTN phone numbers may be sampled to populate certain network addresses wherein these network addresses are traditional phone numbers as opposed to being an IP address.

This phonebook database, although described as being accessible and shared through a network connection, may be available through a private or public network connection. For example, a service provider may have a private database shared by subscribers or an enterprise may have a private database accessible through an internal intranet. Client terminals having users authorized to access the phonebook database may exchange information with the database. Personalized phonebooks may be stored either on the network or within internal memory within the client terminals.

This phonebook database associates client handles or identifiers with recipient availability device capabilities routing identifiers (network addresses (i.e. telephone numbers associated with a PSTN) or communication pathways (i.e., the current IP address (i.e. network identifier) of a network-based communication device may be contained within the network address information within the phonebook database)). Individual client terminals register upon power-up, when a roaming event occurs, or as specified by other periodicities. For example, when a user gains control over a client terminal and attempts a phonebook lookup—an update may be initiated. The request may operate locally if the local phonebook is stored locally and considered to have non-latent or non-stale data. This non-latent or stale data may be identified as data that is within a certain periodicity.

As previously stated, multiple network addresses may be associated with an individual client handle. This is because multiple communication pathways may exist for an individual. These multiple pathways may describe pathways to different client terminals or alternate pathways to a single client terminal. For example, these pathways may within a circuit switched telephony network, a packet switched telephony network, or a combination of circuit switched telephony network and packet switched telephony networks. Metadata is then used by phonebook application software to determine which communication pathway is best utilized to deliver the desired communication. Metadata may provide a set of rules wherein the rules specify that for a certain time of day, day of the week or other like information that one network address (communication pathway) may have a higher priority and thus be preferentially selected over another network address. Alternatively, depending on user-specified information an individual may update to the database and indicate that all incoming calls be routed to a mailbox or that only text messages may be received during a given time frame. These selections may also be made based on cost or relationship between the individual caller and the callee.

For example, a caller may pick a multi-mode phone as a client terminal to initiate a call and select a callee within the phonebook stored in the client terminal or accessed by the client terminal. Further, the caller may select an 802.11 pathway, if available, via the phonebook application because the pathway is active and provides a low-cost option. An attempt to establish the call may then be made using this pathway. Alternatively, based on security or other criteria, the caller may select an alternate callee pathway if available. Automatic or manual handoff on either side may be controlled by either both the caller and the callee.

The various cross reference identifiers depicted in FIG. 2 may include one or more user identifiers, terminal identifiers and service provider identifiers. For example, user identifiers 202 may include user name, member handle or other like information. System identifiers 204 may include a system handle, phone number, ESN, stacker card address, or other like information. A provider I.D. 206 may include a provider handle, a network address, a static address, or other like information. In addition to the user system and provider identifiers, metadata may be associated with these identifiers. For example, personal information such as the age, sex, birth date, image, audio clip, video clip, authorization information or other like information may be associated with a user. The terminal identifier may contain information such as manufacturer, model number, software version, multi media capabilities, hardware capabilities, or other like information. The service provider metadata may include contact information.

The data is associatively coupled. For example, user ID 202 may be associated with a system ID 204, provider ID 206, user metadata 208, system metadata 210 and provider metadata 212. Additionally, the user ID may be associated with a user specified or personalized field within the phonebook for a name or nickname, a user name 214, membership handle 216, a nickname 218 (a nickname may be a custom field defined by the user interfacing with the phonebook). System information contained within the phonebook database may include system handle 220, phone number 222, static or dynamic IP network address 224. Provider I.D. information may include provider handle 226, a provider network address 228 or 230. Thus, a single piece of data, or set of data fields, may be used to retrieve associated information on the potential callee to facilitate and manage calls between client terminals.

User identifiers may comprise a user's name or some “handle” that uniquely identifies a user with that service provider. A service provider identifier might comprise a web address, provider name, or the provider's static IP address. The terminal identifier might be a computer name, telephone number, or serial number, for example. User information might be nearly anything related to the user (age, sex, birthdates, current schedule, current usage, etc.). Terminal information might include manufacturer, model number, firmware/software/hardware version, image/video/audio capabilities, processing power, memory/storage capability, battery capability and status, operational status, available CODECs and versions, etc. As with other metadata, the terminal information might be related or not to the overlying service. Service provider information might include zero or more of service descriptions, service characteristics/limitations, service status, billing info, etc.

This information may associate an individual username, identifier or handle with more than one client terminal. This allows a call to be delivered simultaneously or sequentially to one or more client devices where the user is likely to be present based on preset or monitored activity and corresponding time of day and day of week. This likelihood may be based on history (recent and long term) and based on “online” or “active” user and device status. This information may be maintained in the phonebook database located on a remote server or within database memory of individual client terminals used to initiate calls. The call announcements to these terminals may be differentiated based on system capabilities or user availability. This functionality may facilitate call forwarding conferencing between devices. Call forwarding, in general, can involve either a coordinated handoff of IP addresses or proxying. In the latter case, the client terminal initiating the call request need not know of or support the proxy. Calls may be answered from any client terminal to which the call session request is directed. This may allow lower priority devices that receive only a textual or visual call announcement to respond. In one example textual call announcements are provided on every recipient terminal with audible announcements occurring sequentially or in groups on one or more associated devices. After several call announcements (i.e. rings) have occurred, the call announcements on various terminals may change.

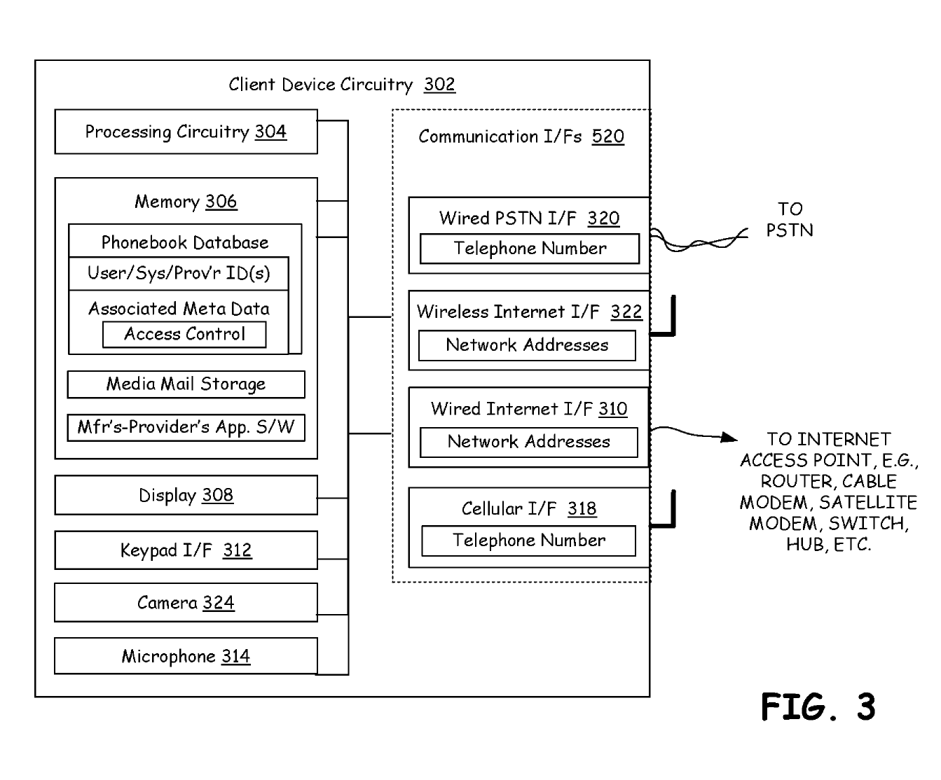

FIG. 3 is a schematic block diagram illustrating exemplary circuitry found within one of the client terminals of FIG. 1, according to one embodiment of the present invention. The telephony circuitry of client terminal 302 includes host processing circuitry 304, memory 306, display 308 and associated display interface circuitry, wired network interface 310, keypad interface 312 (i.e. user input circuitry), microphone/speaker 314, camera 324, cellular network interface 318, PSTN interface 320, and wireless network interface 322. The network interface 310, cellular network interface 318, PSTN interface 320, and wireless network interface 322 may be referred to collectively as communication interface circuitry to support both circuit switched telephony networks and packet switched telephony networks. Host processing circuitry 304 may be a microprocessor, a digital signal processor, an application specific integrated circuit, a state machine, an FPGA, and/or other circuitry that is operable to execute software instructions and to manipulate data. Memory 306 may be RAM, ROM, PROM, hard disk drive, and/or other components capable of storing software instructions and data. (i.e., the phonebook application software and local portion of the phonebook database.) Remote memory may also be available to store the contact associations of the phonebook database. Network interface 310 may support wired or wireless communications according to applicable communication protocol standards.

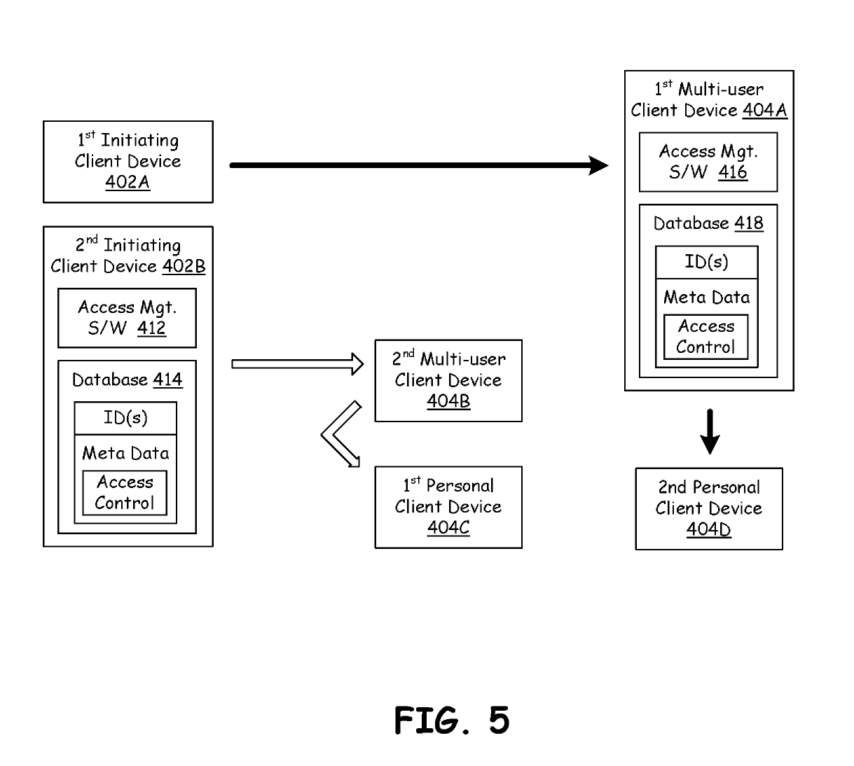

The phonebook database as discussed with reference to FIG. 2 may be all or in part stored within memory 306. Additionally, contained within memory 306 and executed within processing circuitry 304 may be phonebook application software that allows a user to interface with the phonebook database. It should be noted that although memory 306 is shown as containing the phonebook database, all or a portion of the data contained within the phonebook database may be contained and accessed through the phonebook software application via a network connection to a remote server where the phonebook database may be stored. The operation of this phonebook software application may be discussed in further detail with reference to FIG. 5 and following. This phonebook application software 328 allows the caller to access information within the phonebook. Additionally, the recipient may adjust how calls are received with the software.

The wired network interface 310 and wireless network interface 322 may support packet switched network communications as was previously shown with reference to FIG. 1. Additionally, these interfaces may provide recipient of availability information to the phonebook application software. This information may be used to update the availability of the recipient through various communication pathways. Thus, the client terminal may support communications with a router, cable modem, satellite modem, a switch, a hub, and/or another device. Further, the interfaces may support WLAN communications, cellular communications, or other packet switched communications. Not all client devices utilize all of the interfaces 310, 318, 320, and 322. For example, as illustrated in FIG. 1, the client terminal 106, a personal computer, is only configured with wired interface 310.

Host processing circuitry 304 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. Memory 306 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 304 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory stores, and the processing circuitry executes, operational instructions.

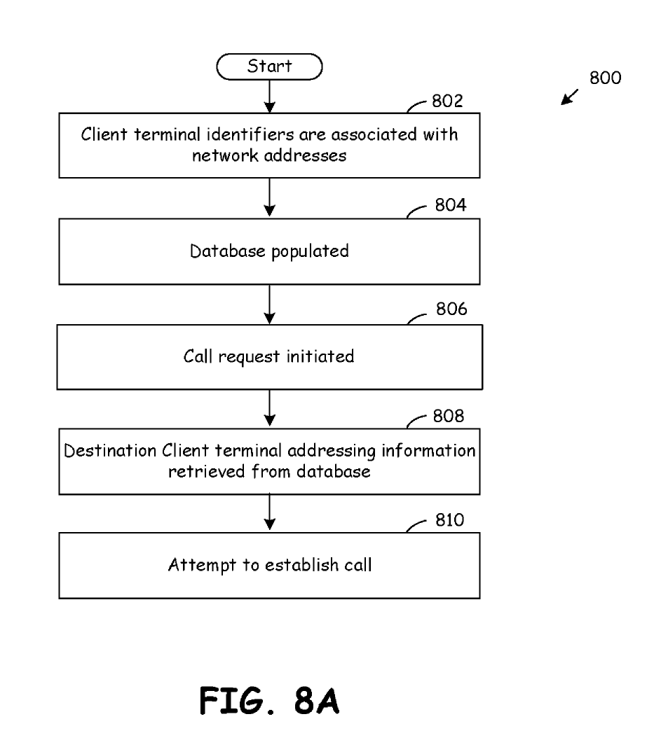

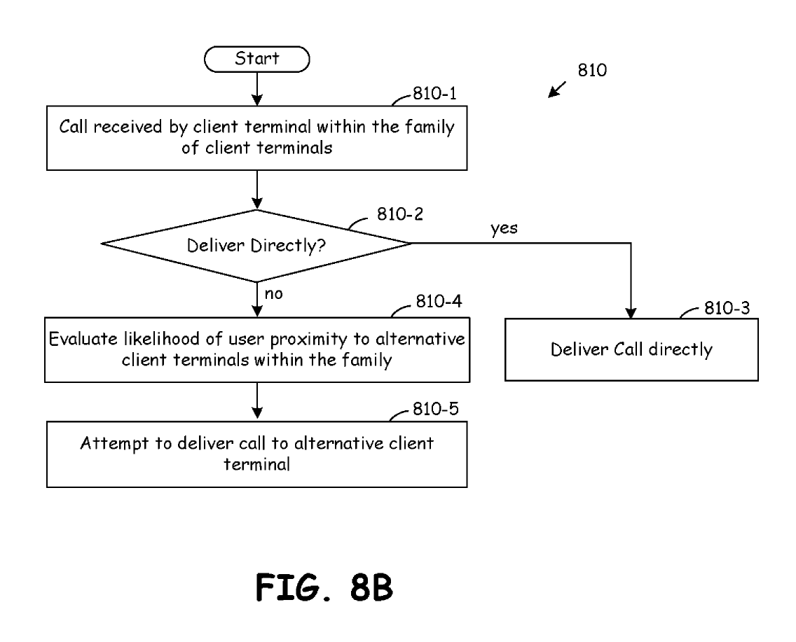

Client terminal and the client device circuitry 302 supports call exchange with a second or recipient client terminal. The communication interfaces allow the client terminal to establish communications with various available switched telephony networks. Specifically, wired interface 310 and wireless interface 322 allow communication to be established with a packet switch network. When initiating a call the user will interface through the display 308, keyboard interface 312, or microphone 314 to initiate a call. Initiation of a call may involve inputting a handle that uniquely identifies the user associated with the destination terminal. The client terminal may then access a database to obtain address or vectoring information for the destination terminal. This process may be facilitated by display screens such as those presented in FIG. 7 and FIG. 8. Both the initiating and destination terminals not only store information in memory 306 but may upload this information or a portion of this information to the public or private databases. In this way processing circuitry 304 may properly configure the communications with the client termination for communications with the recipient terminal based on the terminal and provider capabilities as well as user-defined inputs provided to both the initiating and the destination client terminal. Additionally, it may be desirable to simultaneously establish communications via multiple communication pathways to one or more recipient terminals. These multiple communication pathways may support different media capabilities. For example, a first pathway may be used to support voice while a second is used to support video or images.

When multiple client terminals 302 are located within a common environment or when multiple users are sharing one or more client terminals, management of communications, both incoming and outgoing, may be required. In the case where multiple client terminals 302 are located within a common environment, each client terminal may be associated with at least one handle (user) and/or network address. The devices may know the handles and network addresses of each client terminal within this “group” of client terminals.

These client terminals may support network based communications using a service provider such as but not limited to Skype, AOL's Instant Messenger (AIM), Microsoft MSN Messenger, Yahoo Messenger, and other like services that provide text, voice, and video services.

User defined metadata may describe how calls are to be handled based on the time of day user, time of day for the call request, time of day for the client terminal(s) associated with the destination IP addresses, day of week for the user, day of week for the call request, day of week for the client terminal(s) associated with the destination IP addresses, geographic location of the user, geographic location initiating the call request, geographic location of the client terminal(s) associated with the destination IP addresses, expected proximity of the user to the VoIP client terminal(s) associated with the destination IP addresses, and/or the relationship of the user to a party initiating the call request to the user receiving the call.

In other embodiments, these client terminals may be associated with a number of network addresses. Individual network addresses may be associated with the type of incoming call, the specific communication pathway, or other factors associated with the communication. For example, a client terminal may have one IP address for each communication pathway or link. This may be realized as specific addresses for voice communication and other IP addresses for a text, multimedia or audio/video communication. Other network addresses may be available for technical support.

Vectoring information to the service providers may be retrieved in place of specific network addresses associated with individual client terminals. Thus, when a first client terminal initiates a call or call request, the first client terminal retrieves vectoring information from phonebook database. This vectoring information may include a second service provider network address that directs the first client terminal to the second client terminal. The second service provider then provides the network address of the destination client terminal directly to the first client terminal. The first client terminal then may use the network address to establish a call with the second client terminal.

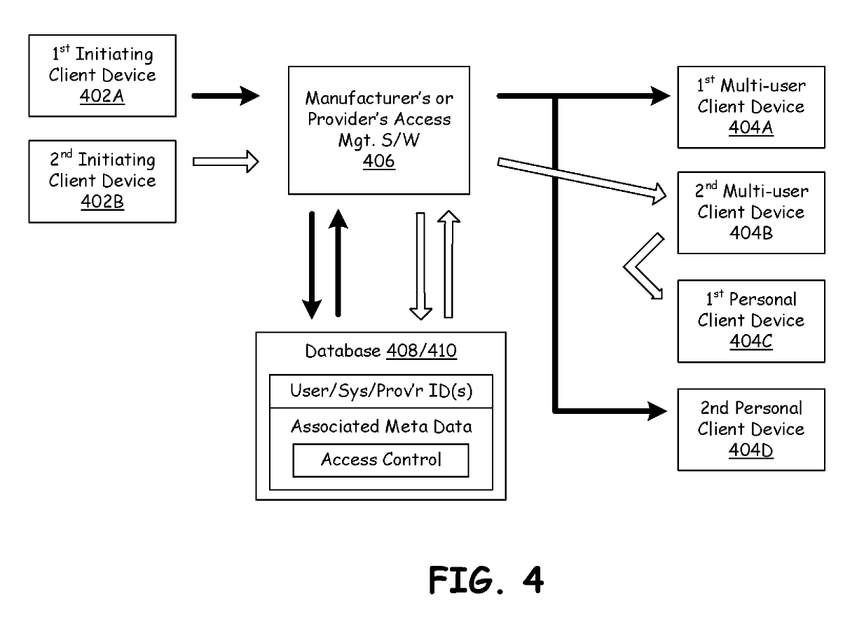

FIG. 4 illustrates how information may flow in order to facilitate a call or communication between a first client device 402A and the destination client device 404A located within a group of client devices associated with a recipient. Each client device may contain in local memory or have access to a local database. This local database may be associated with multiple client devices. Calls may be directed by the initiating terminal to a number of devices wherein the selection of devices may be prioritized based on availability and capability data.

Client terminals 404A-D may maintain local status parameters of that client terminal and associated and current users associated with the recipient client devices. Each device may also maintain and exchange all or a portion of the status parameters from other devices outside the immediate family such as friends and business associates.

Metadata associated with users and client handles may be used by application software to manage network based communications (call delivery) within set of recipient terminals. For example a user or client handle may be primarily associated with an individual client terminal, such as client terminal 404D. However metadata may indicate that the user or client handle primarily associated with client terminal 404D may be available via a client terminal 404A.

The priority of devices chosen to receive the call may be determined by a software application executed within the receiving client device or a local server. The flow of the call from initiating device 402A indicates that the call may be directed to devices 404A and 404D. Client device 404A may be a multi-user device associated with the intended call recipient while device 404D is a personal device that may be uniquely associated with the intended call recipient. This call may be delivered simultaneously to these devices or sequentially (i.e. first personal client device 404D and then multi-user device 404A). Furthermore the call announcements to these devices may differ.

FIG. 5 depicts an example where access control is associated with call delivery. This access control may be managed via either the calling client device or the recipient client device. In a first example, calling client terminal, 402A attempts to establish a call with a user associated with a client device. This call may be initially received by a first client device, 404A. Access Management software 416 and the local database 418, contained within memory of the first multi-user client device 404A or executed on a server accessible to the first client device, may verify the access control. Should access be granted and the call delivery fail, the call may be forwarded or proxied to a second personal client device 404D associated with the user. The example associated with the second initiating client device 306B indicates that access management software 412 and local database 414 may be executed by client device 402B. On providing the appropriate access information to establish the call, the call may be routed to a first multi-user client device 404B. This call may then be vectored or redirected should the call delivery attempt fail to another client device such as personal client device 404C. Other embodiments may seek to deliver this call to both terminals simultaneously.

Alternatively, the set of recipient terminals may determine the likelihood of user proximity to individual recipient terminal based on historical information, current usage, time of day information, user provided information or other like information. Instead of primarily routing the call to a predetermined terminal or set of terminals, the call may first be routed to the device having the greatest likelihood of user proximity to the client terminal. After this first delivery attempt fails, the call may be proxied to another client terminal. Such an example is shown with respect to the call from the second initiating device 402B. This call is first delivered to client device 404B and then proxied to client device 404C. When the call is not successfully delivered to prioritized client terminals, an announcement either audible or visual may be displayed on all or a subset of client terminals or is proxied or vectored to another destination.

FIG. 6 depicts various display sequences of a client telephony device screen, each sequence illustrating various interactions with one or more phonebook databases to facilitate a call or communication exchange in accordance with one or more embodiments of the present invention. In a first example, the phonebook application software presents to the user several display screens that facilitate initiating a call. Scroll down menu 462 initially allows a user to highlight and select an individual recipient by a contact handle or recipient identifier. Once a recipient has been selected, a second display 464 may be presented. Display 464 allows the user to determine how the call should be routed to the intended destination. For example, the call may be routed to all available addresses associated with the intended user or a subset such as those associated with “work” or “home.” As shown here, the “work” network addresses are selected to be searched. Once selected status screen 466 is displayed. Status screen 466 depicts a status of placing the call to these “work” addresses. As shown within status display screen 466, the call is attempting to be placed, however, an attempt to deliver via a traditional PSTN phone failed as well as two VOIP options that were available. These options may be prioritized. In this case perhaps the PSTN was contacted first, followed by a first VoIP address, then a second VOIP address which is then followed by a cellular connection. This example shows how calls may be delivered to a set of terminals associated with sets of recipient terminals.

In a second example, depending on how the adaptive phonebook application software is configured and what preferences are entered by the user, a call may be simultaneously delivered or sequentially delivered to every available network address associated with the intended user. In this case, display screen 468 allows the user to choose a recipient (i.e., “Quentin Bennett”). Then display 470 presents the status of attempting to deliver the call to the various terminals associated with “Quentin Bennett.” Display screen 470 indicates that the first subset, (i.e. a VoIP and PSTN address) were first attempted and then the VoIP laptop and cell phone are being contacted simultaneous to establish a call. Different call announcements may be associated with each terminal or set of terminals.

In a third example, “Sam Smith” is selected on display screen 472 after the intended callee is identified, the application may simply describe the process of searching for the callee does not necessarily identify display 474 the destinations that it is attempting to contact.

FIG. 7 depicts various further examples of a client telephony device's screen which displays select portions of content, including media types, recipient availability, and available networks, in accordance with one or more embodiments of the present invention. In exemplary display screens 476 and 478, icons are used to convey additional information. For example, icons may indicate available media type and networks available with individual callees. Alternatively, they may indicate the availability of the recipient to the callee. As shown, different communication capabilities may be associated and displayed by the phonebook application software. The client and server phonebook application software may interact to update the phonebook databases with network addressing, link availability, and pathway performance characteristics or communication pathway capability information. For example, associated with each pathway are link availability status icon(s) and pathway performance characteristic icon(s) that may be displayed to the user. Parameters for each are stored within memory, typically in a database, and in association with the handle of the contact (i.e. recipient). The link availability icon(s) and associated one or more parameters indicate that the link is down or available, the recipient device is sleeping, powered down, available, or in use. This may also indicate what media capabilities and costs are associated with the link. The recipient device status, such as do not disturb (DND), text messages only, on a call, offline, on-vacation, in meeting, at-home, at-work, sick, etc., could have one or more graphical identifiers associated with the contact handle. These would of course apply to each and every pathway, and each and every recipient telephony device. The pathway performance characteristic icon(s) and one or more associated parameters indicate that pathway bandwidth, QoS, delays, media type limitations, and security requirements. This helps to ensure that current data, received by the server phonebook application software can update remote phonebook database or be distributed to client phonebook application software to update local phonebook database(s). The results of these interactions may be summarized in the exemplary displays.

Display 476 contains icons 480 (i.e. pathway performance characteristic icon(s)), which represent the media types that the intended callee may receive. For example, the callee, “Thomas,” may be able to receive a video call, a picture a text message, or a voice message as indicated by the non-darkened icons. The types of communications that the callee can receive may be indicated by highlighted icons while a darkened icon indicates the inability of the callee to receive that type of communication. This may be updated dynamically depending on the client devices that are active or associated with the callee wherein this information is provided to the adaptive phonebook.

Display screen 478 indicated what kind of network communications the callee may receive wherein the status is indicated by individual icons 482 (i.e. link availability status icon(s)). For example, here a cellular icon, a PSTN icon and a VOIP icon may be associated with individual callees wherein the availability of the callee through these networks is indicated through the icon. For example, “Robert” may be available via a cellular connection or a VOIP connection but is unavailable via PSTN as indicated by the darkened PSTN icon. The user may then highlight individual icons and select that as the means of delivering the communication or call to the intended callee.

FIGS. 8A-10 provide logic flow diagrams that relate to specific operations performed in accordance with embodiments of the present invention. FIG. 8A provides a logic flow diagram illustrating a method of servicing a call between a source client terminal and a destination client terminal. Operations 800 begin with step 802. In step 802, client terminal identifiers are associated with client terminal network addresses. These associations are stored within a shared database available through a network connection. After this shared database has been populated in step 804, the shared database may be accessed to service call requests initiated from a source terminal in step 806. This call request should include a destination identifier such as a username, handle or other identifier. In step 808, the shared database is accessed based on the destination identifier within the call request to retrieve a network address recipient availability and media capabilities associated with the destination client terminals. In step 810, the source client terminals may then attempt to establish a call with the destination client terminal using the network addresses retrieved in step 808. This call may be a voice communication, such as VoIP or any combination of voice, audio, video, text or between the source client terminal and destination client terminal.

The data contained within the phonebook databases may be periodically updated. As IP addresses are dynamically assigned or recipients move, it may become necessary for client terminals to update the phonebook database periodically or when specific events occur. These periodic updates maybe done using messaging services such as, but not limited to, text messaging, short-messaging services (SMS), email communications, instant messaging (IM), enhanced messaging service (EMS), and multi-media messaging services (MMS).

The metadata contained within the shared database may also describe the communication capabilities, terminal capabilities and network capabilities. The communication capabilities and terminal capabilities may describe the types of communications that the terminals may support. For example, whether or not voice, text or multimedia communication capabilities are present. In addition to describing the capabilities of the terminal, user defined criteria regarding communications, the network capabilities associated with the client terminal may be included in the metadata. The network capability information may include bandwidth limitations, or whether or not dedicated band width is available.

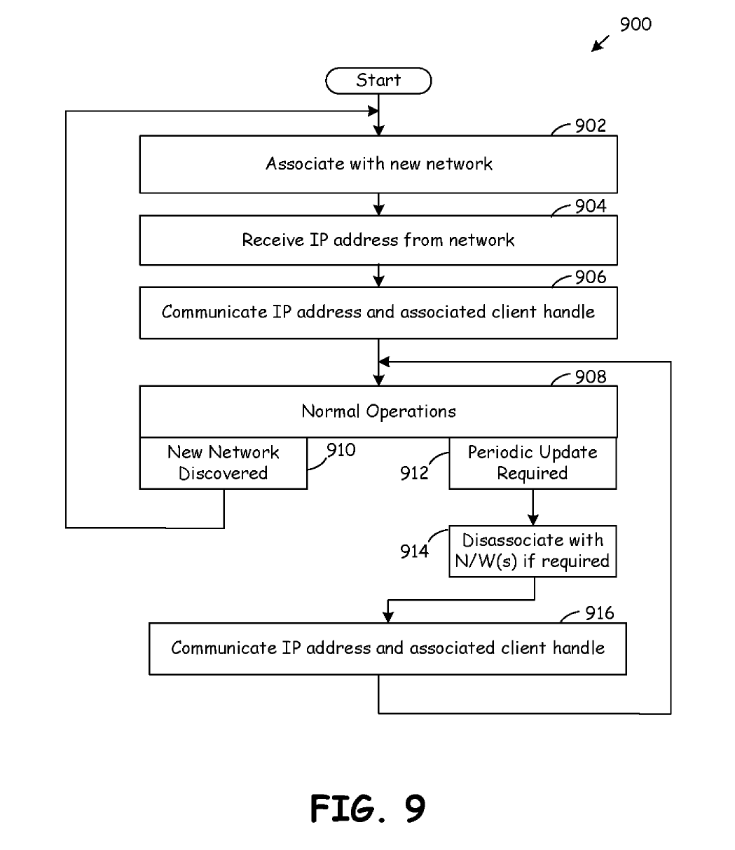

FIG. 9 is a flow chart illustrating operations 900 according to one embodiment of the present invention. These operations commence with a client terminal associating with a particular network in step 902. This new network may be a wireless network or a wired network. Upon association with the new network, the client terminal exchanges user information with the new network and the new network registers the client terminal. Registration may require password exchange from the client terminal to a point of access of the network, e.g., access point 140 or 142 of FIG. 1. The network then assigns a unique IP address to the client terminal and transmits the IP address to the client terminal in step 904. In response to receiving the IP address from the network, the client terminal communicates the IP address and additional information (i.e., username, handle, identifier and other metadata) to either the service provider or the shared database in step 906. For each IP address, the client terminal may report metadata, such as recipient availability new network type, current loading parameters of the new network, current noise/interference properties of the connection that the client terminal has to the new network, location information, security information and/or power usage characteristics performed by the client terminal in communicating with the new network. Additional information or metadata that may be reported by the client terminal may further include the cost associated with communicating via the new network, a user desirability of communicating via the new network, security information regarding the new network, and an access point IP address of the new network with which the client terminal associates, if available.

Referring again to FIG. 1, client terminal 102 may roam to the service area of access point 140 from the service area of access point 142. In this example, the client terminal is previously associated with access points 142 as well as with access point 140. Upon associating with the new access point 140, client terminal 102 becomes associated with the access point 140 and receives an IP address. In response, the client terminal 102 communicates the new IP address access point 142. Further, with the IP address reported, the client terminal may report the additional information as well. This report may also disassociate the client terminal from the previous network if applicable.

Referring again to FIG. 9, after communication of the IP addresses and the additional information is complete, normal operations are established in step 908. When the client terminal discovers another new network in step 910, operation returns to step 902. During normal operations 508, the client terminal may determine that a periodic update is required in step 912. This update may be required by a predetermined schedule or other like criteria. Such periodic update may require that the client terminal disassociate with one or more networks with which it is currently associated in step 914. When the client terminal disassociates with a network, the IP addresses and additional information may be directly or indirectly communicated to the shared database so that latency of addressing information within the shared database is reduced. From step 916, operation returns to step 908.

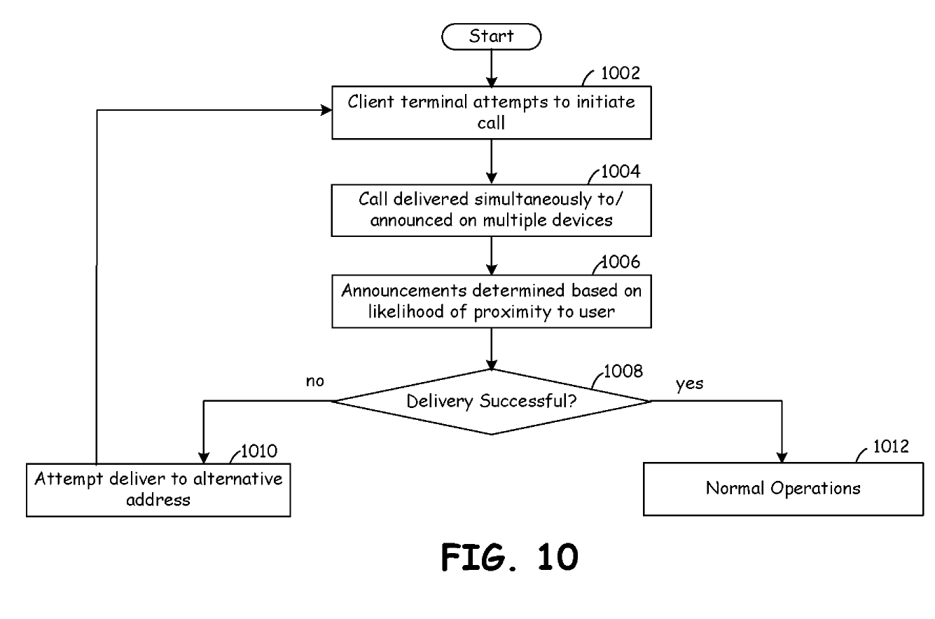

The call may be announced differently on individual devices. For example, a device may specify that silent notifications are to be utilized only. FIG. 10 provides a logic flow diagram wherein a first telephony device initiates a call to one or more telephony devices in step 1002. Different call announcements may be delivered in step 1004 to individual telephony devices. These call announcements may be determined in step 1006 based on expected callee proximity to the recipient device in accordance with one or more embodiments of the present invention. Additionally, devices likely to have a greater proximity to the user may present an audible announcement while devices having a lower likelihood of proximity to the user may merely present a visual announcement. However, any device receiving the call request may be utilized to complete the call as determined at decision point 1008. Should the call be completed, the normal operations 1012 resume. Otherwise an attempt to deliver the call to an alternative address or mailbox may be initiated in step 1010.

In other embodiments, textual indications of incoming calls are displayed on every device with audio indications occurring sequentially or in groups on one or more associated devices. For example, when a call is received during a user's “office hours,” the first audible ring is presented simultaneously at office client terminals. After several ring attempts, the initiating client terminal is informed that other locations are being checked with a “checking other locations” message to the caller. This may attempt to deliver the call to a mobile phone, pc and vacation or home desktop client terminal having a lower likelihood of proximity to the user. Whichever device that receives the pickup is connected to the caller and the ringing and attempts at other devices terminates. Voice mail or other alternative mailboxes is not triggered by all devices, but instead just one upon identifying the failure to deliver the call.

The identity of the client terminal device receiving the call may be used to update the database for future incoming calls. In this way, the client terminal receiving the call is at least temporarily assigned a higher likelihood of proximity to the user.

A call conferencing situation may arise in a home, where multiple client terminals are “associated” and ring together, in sequence or round-robin ringing) if the intended recipient is unidentified or whereabouts within the house are unknown. In one embodiment, the shared database has knowledge of such association and delivers pluralities of IP addresses to the caller's system to perform such call functionality. In another, a local server acts as a proxy or branch exchange to establish the ring pattern to the association and delivers only a single IP address upon pickup to the calling system.

In yet another embodiment, each associated client terminal knows the current IP address of the associated others. The shared database delivers one of the IP addresses to the client terminal initiating the request. The initiating client terminal sends a call request to the single IP address provided by the shared database. The recipient client terminal then contacts the other associated client terminals to manage the call pattern. If the recipient client terminal answers, the call continues using the recipient's network address. Alternatively, if an associated client terminal answers, either the recipient acts as a proxy for the answering client terminal without troubling the calling system or the recipient and/or answering client terminal coordinate an IP handoff with the calling system.

Three way calls can also operate with or without the knowledge of the other client terminals. With other side knowledge and participation, a three way (or more) call can be established during a point to point 2 client terminal system by having one client terminal establish the request and have all 3 client terminals exchange packets and combine them before presentation via the speakers. Another approach is to have the client terminal that establishes the 3^{rd} and so on call to combine packets of and for the 3^{rd} client terminal effectively act as a proxy between the two phones. With such configuration, neither the 1^{st} or 3^{rd} phones need to know that the other even exists. The server might also perform such combination but will require significant processing resources to handle wide deployment. Lastly, the 2^{nd} phone may proxy but not recombine packets for the 3^{rd} phone (i.e., merely act as a forwarding node) for the 1^{st} and 3^{rd} phones. Both of such phones will then have the obligation to process both packet streams without having to know each others IP addresses.

The metadata may contain network capabilities information, communication capabilities information, terminal capabilities information, user defined criteria, and/or security information. In one embodiment this information may describe the CODECs which are to be employed in order to support the communications between the first client terminal and second client terminal. Other types of information that may be associated with the client terminal via the shared database may be security information. Security information may require that the second client terminal contain authorization information for the first client terminal prior to supplying the network address to the first client terminal. In other embodiments this metadata may be CODEC capabilities, multimedia capabilities, latency information, user information, user email address information, user phone number information, VoIP client terminal location information, quality information, VoIP service provider, session information, network information, call authorization criteria, pathway information, port information. User defined metadata may describe how calls are to be handled based on the time of day user, time of day for the call request, time of day for the client terminal(s) associated with the destination IP addresses, day of week for the user, day of week for the call request, day of week for the client terminal(s) associated with the destination IP addresses, geographic location of the user, geographic location initiating the call request, geographic location of the client terminal(s) associated with the destination IP addresses, expected proximity of the user to the VoIP client terminal(s) associated with the destination IP addresses, and/or the relationship of the user to a party initiating the call request to the user receiving the call.

The shared database may associate more than one network address with a username, handle, or identifier. This may involve associating more than one device with an individual username, handle or other like identifier where different devices have unique network addresses associated with the device, or where multiple network addresses are associated with a single device. Priority may be given to a first network address. Should that network address fail, an alternative network address may be sought for the destination terminal. This priority may be based on the most likely location of the user associated with the username, handle or identifier. Where multiple network addresses are associated with a destination terminal or a destination user, the different types of communication available may depend on the network address selected from the shared database. For example, a call may initially seek a voice call. Should the voice call fail, text instant messaging (IM) may be established between the source client terminal and destination client terminal. Additionally, should the destination client terminal be unavailable, the call may be directed to a voice mailbox having a different network address.

Some network connections are not robust or the addressing and recipient availability information may become stale. The former is the case when a client terminal is on the fringe of a wireless coverage area and/or when the client terminal is roaming outside its normal service area. Further, the client terminal may be engaged in some activity such as participation with another network or may be asleep with respect to a particular network. Such other activity may prevent direct receipt of packet data based call directed at a specific network address. In such cases, indirect delivery may be attempted.

In summary, the present invention provides telephony circuitry, within calling or recipient telephony devices, supports the exchange of communications between the telephony devices. These telephony devices may include a screen and a user input device. User input interface circuitry receives input signals from the user input device. Display interface circuitry couples to the screen. Communication interface circuitry couples switched telephony networks to support a number of pathways. Processing circuitry communicatively couples to the display interface circuitry, the communication interface circuitry, and the user input interface circuitry. Memory stores contact associations, where the contact association includes recipient availability information and contact handle associated with the recipient. The processing circuitry responds to input signals received via the user input interface circuitry to cause the display of the contact association through interaction with the display interface circuitry. The processing circuitry then responds to a second input signals by establishing the call session request to recipient telephony device(s) based on the recipient availability information.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. Telephony circuitry of a calling telephony device used by a caller to establish a call session with a recipient, the calling telephony device having a screen and a user input device, the telephony circuitry comprising:
user input interface circuitry communicatively coupled to receive input signals from the user input device;
display interface circuitry communicatively coupled to the screen;
communication interface circuitry coupled to a plurality of telephony networks
the communication interface circuitry supports both a first pathway associated with a first telephony network, and a second pathway associated with a second telephony network;
processing circuitry communicatively coupled to the display interface circuitry, the communication interface circuitry, and the user input interface circuitry;
a memory storing a contact association, the contact association comprising a first recipient identifier associated with the first pathway, a second recipient identifier associated with the second pathway, recipient availability information, and a contact handle associated with the recipient; and
the processing circuitry responds to a first of the input signals received via the user input interface circuitry by causing the display of the contact association, retrieved from the memory, on the screen through interaction with the display interface circuitry;
the processing circuitry responds to a second of the input signals received via the user input interface circuitry by establishing the call session request to recipient telephony device(s) based on the recipient availability information; and
the processing circuitry establishes a call session to recipient telephony device(s) that accept the call session request.

2. The telephony circuitry of claim 1, wherein the plurality of telephony networks comprising a circuit switched telephony network and a packet switched telephony network;

3. The telephony circuitry of claim 1, wherein the processing circuitry sequentially establishes the call session requests to recipient telephony device(s) via the first pathway and the second pathway based on a predetermined priority.

4. The telephony circuitry of claim 1, wherein the processing circuitry simultaneously establishes the call session requests to recipient telephony device(s).

5. The telephony circuitry of claim 1, wherein the processing circuitry establishes the call session requests to recipient telephony device(s) via the first pathway and the second pathway based on recipient availability information associated with the recipient telephony device(s).

6. The telephony circuitry of claim 1, wherein the processing circuitry simultaneously establishes the call session requests to a plurality of recipient telephony devices, wherein a first set of recipient telephony devices exhibits a first call announcement in response to the call session request and a second set of recipient telephony devices exhibits a second call announcement in response to the call session request.

7. The telephony circuitry of claim 6, wherein the first call announcement comprises an audible call announcement and the second call announcement comprises a visual call announcement.

8. The telephony circuitry of claim 6, wherein the second call announcement changes to an audible call announcement after a predetermined amount of time expires.

9. The telephony circuitry of claim 6, wherein membership of a recipient telephony device within the first set of recipient telephony devices or second set of recipient telephony devices is determined from recipient availability information.

10. The telephony circuitry of claim 1, wherein the call session request is at least initially delivered to a recipient telephony device having a greatest likelihood of recipient proximity.

11. The telephony circuitry of claim 1, wherein accepting the call session request on any of the recipient telephony device(s) halts call announcements on all the recipient telephony device(s).

12. The telephony circuitry of claim 1, recipient input signals received via any of the recipient telephony device(s) directs the call session request to a subset of recipient telephony device(s).

13. The telephony circuitry of claim 1, recipient input signals received via any of the recipient telephony device(s) directs the call session request to an additional recipient retrieved from recipient telephony device memory.

14. Telephony circuitry of a recipient telephony device used to establish a call session with a caller in response to a call session request, the recipient telephony device having a screen and a user input device, the telephony circuitry comprising:
user input interface circuitry communicatively coupled to receive input signals from the user input device;
display interface circuitry communicatively coupled to the screen;
communication interface circuitry coupled to at least one switched telephony network, the communication interface circuitry supports both at least one telephony pathway;
processing circuitry communicatively coupled to the display interface circuitry, the communication interface circuitry, and the user input interface circuitry;
a memory storing recipient availability information; and
the processing circuitry responds to the call session request by:
retrieving recipient availability information from memory;
presenting a first call announcement when recipient availability information compares favorably to recipient availability criteria; and
presenting a second call announcement when recipient availability information compares unfavorably to recipient availability criteria.

15. The telephony circuitry of claim 14, wherein the processing circuitry establishes the call session in response to a first recipient input signal.

16. The telephony circuitry of claim 14, wherein the processing circuitry directs the call session request to at least one additional recipient telephony device in response to a second recipient input signal.

17. The telephony circuitry of claim 14, wherein the second call announcement initially comprises at least a visual call announcement that changes into at least an audible call announcement after a predetermined amount of time expires.

18. The telephony circuitry of claim 14, wherein the first call announcement comprises an audible call announcement and the second call announcement comprises a visual call announcement.

19. The telephony circuitry of claim 14, wherein the recipient telephony device belongs to a set of recipient telephony devices, wherein the set of telephony devices comprises a first subset of recipient telephony devices and a second subset of recipient telephony devices, and membership within the first subset of recipient telephony devices and second subset of recipient telephony devices is determined from recipient availability information.

20. The telephony circuitry of claim 19, wherein accepting the call session request on any recipient telephony device within the set of recipient telephony devices halts call announcements on all the recipient telephony devices within the set of recipient telephony devices.

21. The telephony circuitry of claim 19, recipient input signals received via any of the recipient telephony device(s) directs the call session request to a subset of recipient telephony device(s).

22. The telephony circuitry of claim 19, recipient input signals received via any of the recipient telephony device(s) directs the call session request to an additional recipient retrieved from recipient telephony device memory.

23. Telephony circuitry of a recipient telephony device used to establish a call session with a caller in response to a call session request, the recipient telephony device supporting communication of voice data and having a supplemental media capability, the recipient telephony device having a screen and a user input device, the telephony circuitry comprising:
user input interface circuitry communicatively coupled to receive input signals from the user input device;
display interface circuitry communicatively coupled to the screen;
communication interface circuitry coupled to at least one switched telephony network, the communication interface circuitry supports both at least one telephony pathway;
processing circuitry communicatively coupled to the display interface circuitry, the communication interface circuitry, and the user input interface circuitry;
a memory storing recipient availability information and supplemental media capability of the recipient telephony device; and
the processing circuitry responds to the call session request by:
retrieving recipient availability information from memory;
presenting a first call announcement when recipient availability information and call session media requirements compare favorably to recipient availability criteria and supplemental media capability;
presenting a second call announcement when recipient availability information or call session media requirements compare unfavorably to recipient availability criteria and supplemental media capability.

24. The telephony circuitry of claim 23, wherein the recipient telephony device belongs to a set of recipient telephony devices, the memory stores supplemental media capability information of each recipient telephony devices within the set of recipient telephony devices, and the processing circuitry responds to the call session request by directing the call to at least one additional recipient telephony device within the set of recipient telephony devices having recipient availability criteria and supplemental media capability that compares favorably to the recipient availability information and call session media requirements.

25. The telephony circuitry of claim 23, wherein the processing circuitry directs the call session request to at least one additional recipient telephony device in response to a second recipient input signal.

26. The telephony circuitry of claim 23, wherein the second call announcement initially comprises at least a visual call announcement that changes into at least an audible call announcement after a predetermined amount of time expires.

27. The telephony circuitry of claim 23, wherein the recipient telephony device belongs to a set of recipient telephony devices, wherein the set of telephony devices comprises a first subset of recipient telephony devices and a second subset of recipient telephony devices, and membership within the first subset of recipient telephony devices and second subset of recipient telephony devices is determined from recipient availability information and supplemental media capability.

28. The telephony circuitry of claim 27, wherein accepting the call session request on any recipient telephony device within the set of recipient telephony devices halts call announcements on all the recipient telephony devices within the set of recipient telephony devices.

29. A method performed by telephony circuitry of a recipient telephony device used to establish a call session with a caller, the recipient telephony device having a screen and a user input device, the method comprising:
receiving a call session request from a caller;
retrieving recipient availability information from memory;
presenting a first call announcement when recipient availability information compares favorably to recipient availability criteria;
presenting a second call announcement when recipient availability information compares unfavorably to recipient availability criteria; and
establishing a call session in response to a first recipient input signal.

30. The method of claim 29, further comprising directing the call session request to at least one additional recipient telephony device in response to a second recipient input signal.

31. The method of claim 29, wherein the second call announcement initially comprises at least a visual call announcement that changes into at least an audible call announcement after a predetermined amount of time expires.

32. The method of claim 29, wherein the recipient telephony device belongs to a set of recipient telephony devices, wherein the set of telephony devices comprises a first subset of recipient telephony devices and a second subset of recipient telephony devices, and membership within the first subset of recipient telephony devices and second subset of recipient telephony devices is determined from recipient availability information.

33. The method of claim 32, wherein accepting the call session request on any recipient telephony device within the set of recipient telephony devices halts call announcements on all the recipient telephony devices within the set of recipient telephony devices.

34. A method performed by telephony circuitry of a recipient telephony device used to establish a call session, having call session media requirements, with a caller, the recipient telephony device supporting communication of voice data and having a supplemental media capability, the recipient telephony device having a screen and a user input device, the method comprising:
receiving a call session request from a caller;
retrieving recipient availability information and supplemental media capability from memory;
presenting a first call announcement when recipient availability information and call session media requirements compare favorably to recipient availability criteria and supplemental media capability;
presenting a second call announcement when recipient availability information or call session media requirements compare unfavorably to recipient availability criteria and supplemental media capability; and
establishing a call session in response to a first recipient input signal.

35. The method of claim 34, further comprising directing the call session request to at least one additional recipient telephony device in response to a second recipient input signal.

36. The method of claim 34, wherein the second call announcement initially comprises at least a visual call announcement that changes into at least an audible call announcement after a predetermined amount of time expires.

37. The method of claim 34, wherein the recipient telephony device belongs to a set of recipient telephony devices, wherein the set of telephony devices comprises a first subset of recipient telephony devices and a second subset of recipient telephony devices, and membership within the first subset of recipient telephony devices and second subset of recipient telephony devices is determined from recipient availability information and supplemental media capability.

38. The method of claim 37, wherein accepting the call session request on any recipient telephony device within the set of recipient telephony devices halts call announcements on all the recipient telephony devices within the set of recipient telephony devices.
